(19) United States
(12) Patent Application Publication
(10) Pub. No.: US 2025/0126600 A1
(43) Pub. Date: Apr. 17, 2025

(54) LOCATION-BASED SERVICES RADIO ACCESS NETWORK CONFIGURATION

(71) Applicant: AT&T Intellectual Property I, L.P., Atlanta, GA (US)

(72) Inventors: Abbas Munawar Fazal, Bridgewater, NJ (US); Anwar Syed Aftab, Budd Lake, NJ (US); Manoop Talasila, Branchburg, NJ (US); Paul Triantafyllou, Mountainside, NJ (US)

(21) Appl. No.: 18/487,010

(22) Filed: Oct. 13, 2023

(51) Int. Cl. H04W 64/00; H04W 4/90; H04W 76/50

(52) U.S. Cl. CPC H04W 64/003; H04W 4/90; H04W 76/50

(57) ABSTRACT

A processing system including at least one processor may apply an input vector to a location-based services recommendation module implemented by the processing system, where the location-based services recommendation module includes at least one location-based service prediction model, and where the input vector includes first characteristics associated with a first cell site of a cellular network. The processing system may obtain an output of the location-based services recommendation module in response to the applying of the input vector, the output including a first plurality of values for a plurality of configurable settings of at least a first network element associated with the first cell site. The processing system may then configure the at least the first network element associated with the first cell site to apply at least one of the first plurality of values for at least one of the plurality of configurable settings.

The present disclosure relates generally to cellular radio access networks and location-based services, and more specifically to methods, computer-readable media and apparatuses for configuring at least a first network element associated with a first cell site to apply at least one of a first plurality of values for at least one of a plurality of configurable settings based on an output of a location-based services recommendation module.

### BACKGROUND

First responders (e.g., firefighters, police, emergency medical service (EMS) personnel, etc.) and/or governmental or quasi-governmental entities (e.g., military, public health entities, hazardous materials (hazmat) units, etc.) may be entitled to access and utilize a priority network, or priority network slice(s) of a cellular network that are configured for use by these entities and their personnel. Such a priority network, or priority network slice(s) may be used for two-way communication involving systems and/user endpoint devices associated with these entities, where reliability of such communications may be of heightened importance. In addition, the Wireless Emergency Alert (WEA) system is capable of providing messages indicative of a variety of types of alerts. Via the WEA system, mobile devices can receive messages pertaining to weather conditions, disasters, child abduction America's Missing: Broadcast Emergency Response (AMBER) alerts, and any alerts for imminent threats to life or property issued by authorized government entities, for example. However, in some cases, a WEA message may not be received by endpoint devices in an alert area due to the lack of proper network coverage, poor signal reception, an endpoint device being set to airplane mode, or off, and so forth.

### SUMMARY

In one example, the present disclosure describes a method, computer-readable medium, and apparatus for configuring at least a first network element associated with a first cell site to apply at least one of a first plurality of values for at least one of a plurality of configurable settings based on an output of a location-based services recommendation module. For instance, a processing system including at least one processor may apply an input vector to a location-based services recommendation module implemented by the processing system, where the location-based services recommendation module includes at least one location-based service prediction model, and where the input vector includes first characteristics associated with a first cell site of a cellular network. The processing system may next obtain an output of the location-based services recommendation module in response to the applying of the input vector, the output including a first plurality of values for a plurality of configurable settings of at least a first network element associated with the first cell site. The processing system may then configure the at least the first network element associated with the first cell site to apply at least one of the first plurality of values for at least one of the plurality of configurable settings.

### BRIEF DESCRIPTION OF THE DRAWINGS

The teachings of the present disclosure can be readily understood by considering the following detailed description in conjunction with the accompanying drawings, in which:

FIG. 1 illustrates an example system related to the present disclosure;

FIG. 2 illustrates a flowchart of an example method for configuring at least a first network element associated with a first cell site to apply at least one of a first plurality of values for at least one of a plurality of configurable settings based on an output of a location-based services recommendation module, according to the present disclosure; and

FIG. 3 illustrates a high-level block diagram of a computing device specially configured to perform the functions, methods, operations, and algorithms described herein.

To facilitate understanding, identical reference numerals have been used, where possible, to designate identical elements that are common to the figures.

### DETAILED DESCRIPTION

The present disclosure broadly discloses methods, computer-readable media and apparatuses for configuring at least a first network element associated with a first cell site to apply at least one of a first plurality of values for at least one of a plurality of configurable settings based on an output of a location-based services recommendation module. To illustrate, location-based services (LBS) may be characterized as network services that are dependent upon and/or tailored to user/endpoint device locations. In one example, location-based services may include, or may rely upon or be integrated with real-time location systems (RTLS) and/or indoor positioning systems (IPS). In accordance with the present disclosure, location-based services may include emergency calling services (e.g., 9-1-1, Enhanced 9-1-1 (E911), or the like), emergency messaging services (e.g., text-2-911), emergency alert broadcast services (e.g., Wireless Emergency Alert (WEA) message broadcasting), mapping and visualization services for first responder personnel and equipment tracking, or the like. In one example, location-based services may also include navigation services, video streaming services (e.g., where video delivery may be location-optimized), and so forth.

Notably, cellular networks may include millions of virtualized node configurations, multiple data management sources, nodes from diverse vendors, different usage patterns across cell sites, and so forth. As 5G cellular network infrastructure continues to expand, the service offerings also increase in complexity and scale. For instance, first responders (e.g., firefighters, police, emergency medical service (EMS) personnel, etc.) and/or governmental or quasi-governmental entities (e.g., military, public health entities, hazardous materials (hazmat) units, etc.) may be entitled to access and utilize a priority network, or priority network slice(s) that are configured for use by these entities and their personnel. In addition, such a priority network, or priority network slice(s) may interface with first responder systems that may include equipment of diverse vendors and that communicate via a variety of different protocols.

Examples of the present disclosure provide a strategic artificial intelligence (AI)/machine learning (ML) framework to configure radio access network components for location-based services. In particular, examples of the present disclosure may provide automated pre-provisioning of network component configurations, may validate configurations through ongoing performance indicator tracking and/or feedback of network personnel and/or users of location based services, and may update AI/ML models in accordance with the performance indicator tracking and/or feedback. Examples of the present disclosure may also leverage LBS network element management tools to implement configuration changes and to monitor performance.

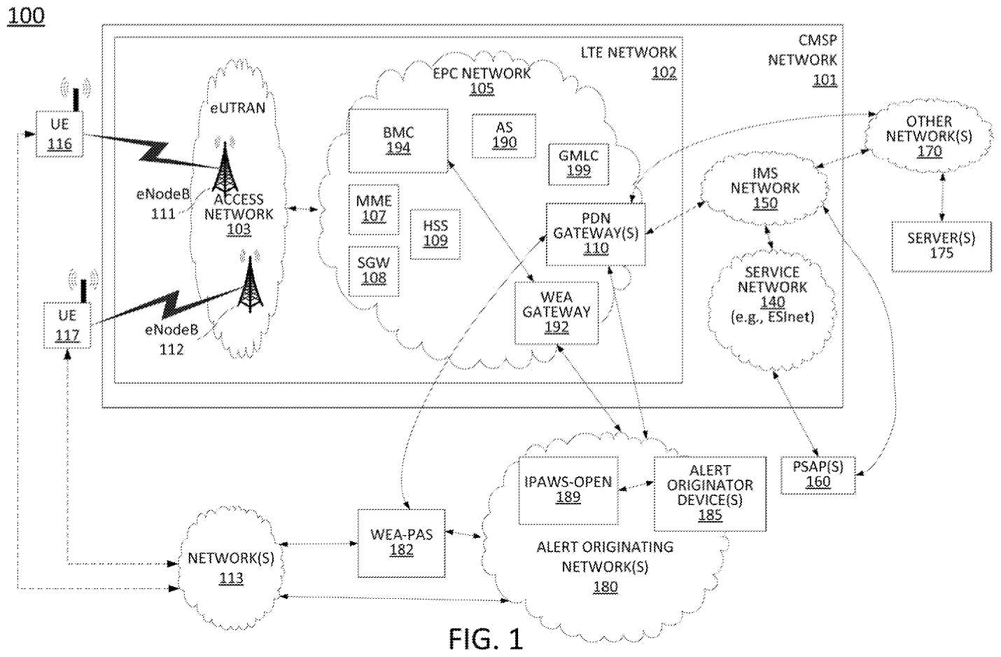

Examples of the present disclosure provide a closed loop end-to-end integrated automation of network element configuration for location-based services. In particular, examples of the present disclosure may iteratively learn through successive provisioning cycles using pre-defined policies along with AI/ML-based knowledge/learning to drive further configuration decisions. For instance, examples of the present disclosure may track network performance indicators (e.g., “key” performance indicators (KPIs)) and evaluate model performance to determine whether and when to retrain. In various examples, machine learning implementations may be fully autonomous, such as via a reinforcement learning (RL) framework, or can follow a semi-supervised learning methodology by providing recommendations and collecting feedback. In addition, in one example, the self-optimizing AI/ML-based processes of the present disclosure may predict erroneous network node configurations impacting location-based services and may recommend or automatically adjust configurable settings accordingly. With such an end-to-end close loop operation, a network operator may thus improve location-based services via timely and proactive configuration setting deployments and updates/corrections. These and other aspects of the present disclosure are described in greater detail below in connection with the discussion of FIGS. 1-3.

To better understand the present disclosure, FIG. 1 illustrates an example network, or system 100 in which examples of the present disclosure may operate. In one example, the system 100 comprises a cellular mobile service provider (CMSP) network 101, which may comprise a Long Term Evolution (LTE) network 102, a service network 140, an IP Multimedia Subsystem (IMS) network 150, and so forth. In the example of FIG. 1, the system 100 may also include network(s) 113, other network(s) 170, and alert originating network(s) 180. FIG. 1 also illustrates various endpoint devices, e.g., UEs 116 and 117, which may comprise cellular endpoint devices, e.g., user equipment or user endpoints (UE) 116 and 117. UE 116 and 117 may each comprise a cellular telephone, a smartphone, a tablet computing device, a laptop computer, a pair of computing glasses, a wireless enabled wristwatch, or any other cellular-capable mobile telephony and computing devices including computing components of connected vehicles, Internet of Things (IoT) sensor devices, and so forth (broadly, “endpoint devices”).

In one example, the LTE network 102 comprises an access network 103 and a core network, e.g., an evolved packet core (EPC) network 105. In one example, the access network 103 comprises an evolved Universal Terrestrial Radio Access Network (eUTRAN). The eUTRANs are the air interfaces of the 3rd Generation Partnership Project (3GPP) LTE specifications for mobile networks. In one example, EPC network 105 provides various functions that support wireless services in the LTE environment. In one example, an EPC network is an Internet Protocol (IP) packet core network that supports both real-time and non-real-time service delivery across a LTE network, e.g., as specified by the 3GPP standards. In one example, all eNodeBs in the access network 103 are in communication with the EPC network 105. In operation, UE 116 may access wireless services via the eNodeB 111 and UE 117 may access wireless services via the eNodeB 112 located in the access network 103. It should be noted that any number of eNodeBs can be deployed in an eUTRAN. In one illustrative example, the access network 103 may comprise one or more eNodeBs.

In EPC network 105, network devices Mobility Management Entity (MME) 107 and Serving Gateway (SGW) 108 support various functions as part of the LTE network 102. For example, MME 107 is the control node for the LTE access-network. In one embodiment, it is responsible for UE (User Equipment) tracking and paging (e.g., such as retransmissions), bearer activation and deactivation process, selection of the SGW, and authentication of a user. In one embodiment, SGW 108 routes and forwards user data packets, while also acting as the mobility anchor for the user plane during inter-eNodeB handovers and as the anchor for mobility between LTE and other wireless technologies, such as 2G and 3G wireless networks.

In addition, EPC (common backbone) network 105 may comprise a Home Subscriber Server (HSS) 109 that contains subscription-related information (e.g., subscriber profiles), performs authentication and authorization of a wireless service user, and provides information about the subscriber's location. The EPC network 105 may also comprise one or more public data network (PDN) gateways 110 which serve as gateways that provide access between the EPC network 105 and various data networks, e.g., other IP networks (e.g., one or more of other network(s) 170), an IMS network 150, and the like. A public data network gateway is also referred to as a PDN gateway, a PDN GW or a PGW.

In one example, service network 140 may comprise one or more devices for providing services to subscribers, customers, and or users. For example, CMSP network 101 may provide a cloud storage service, a web server hosting service, and other services. As such, service network 140 may represent aspects of CMSP network 101 where infrastructure for supporting such services may be deployed. In accordance with the present disclosure, service network 140 may comprise infrastructure hosted by CMSP 101 for public safety entities (e.g., associated with public safety answering point(s) (PSAPs) 160), such as an emergency services IP network (ESInet)).

In one example, other networks 170 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 170 may include different types of networks. In another example, the other networks 170 may be the same type of network. In one example, other networks 170 may represent the Internet in general. As illustrated in FIG. 1, other networks 170 may provide access to one or more servers 175. In accordance with the present disclosure, server(s) 175 may provide one or more location-based services, e.g., in accordance with endpoint device location information from CMSP network 101, such as a navigation service (e.g., route planning/tracking, route recommendations, etc.), a streaming video service (e.g., a content distribution network (CDN) with optimized delivery based on location), and so forth.

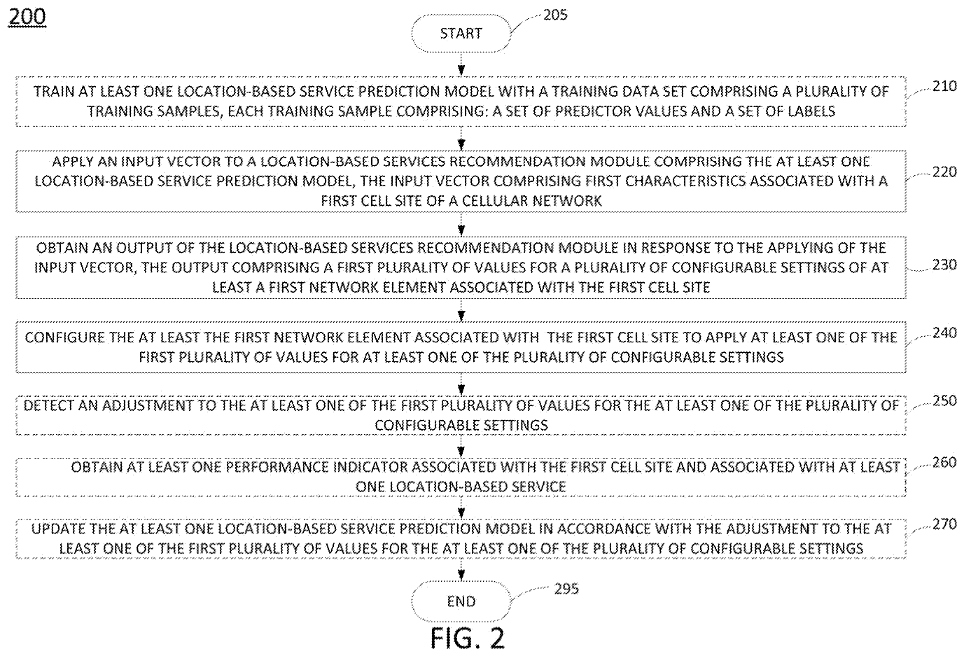

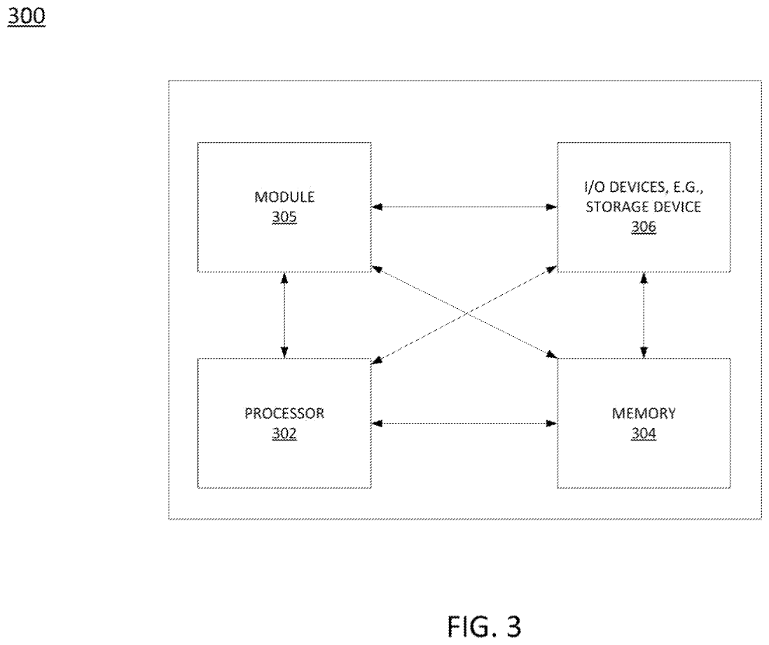

The EPC network 105 may also include an application server (AS) 190. In one example, AS 190 may comprise a computing device or processing system, such as computing system 300 depicted in FIG. 3, and may be configured to provide one or more functions in connection with examples of the present disclosure for configuring at least a first network element associated with a first cell site to apply at least one of a first plurality of values for at least one of a plurality of configurable settings based on an output of a location-based services recommendation module (e.g., such as described in connection with the example method 200 of FIG. 2), and for performing various other operations in accordance with the present disclosure. Accordingly, the AS 190 may be connected directly or indirectly to any one or more network elements of EPC network 105, and of the system 100 in general, that is/are configured to gather and forward location-based services performance information (e.g., KPIs, configuration setting feedback/adjustments, etc.) to AS 190 and to receive instructions from AS 190. Due to the relatively large number of connections available between AS 190 and other network elements, none of the actual links to the application server are shown in FIG. 1. Similarly, links between MME 107, SGW 108, broadcast message center (BMC) 194, gateway mobile location center (GMLC) 199, eNodeBs 111 and 112, PDN gateway(s) 110, and other components of system 100 are also omitted for clarity.

It should also be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In the example of FIG. 1, broadcast message center (BMC) 194 may be configured to receive requests to broadcast wireless emergency alert messages from alert originator (AO) devices 185 deployed in one or more alert originating networks 180, each of which may be associated with an authorized alert originator. In this regard, BMC 194 may alternatively or additionally be referred to as a cell broadcast center (CBC), an emergency alert server (EAS), or a WEA server. In one example, BMC 194 may be deployed in a network operations center (NOC) of CMSP network 101, e.g., an entity operating the EPC network 105, LTE network 102, access network 103, and so on. In addition, in one example, alert originating network(s) 180 may also include a Federal Emergency Management Administration (FEMA) Integrated Public Alert and Warning System (IPAWS)-Open Platform for Emergency Networks (IPAWS-OPEN) server 189. For instance, one of the alert originator devices 185 may generate an alert (e.g., a WEA message), which may be sent to IPAWS-OPEN server 189. IPAWS-OPEN server 189 may then disseminate the WEA message to one or more CMSP networks (e.g., including at least CMSP network 101).

In one example, BMC 194 may be configured to broadcast WEA messages to endpoint devices devices being served by wireless access networks in an alert area, such as endpoint devices/UEs 116 and 117. For example, BMC 194 may confirm that a message content for the WEA message and other aspects of the request, such as the time duration, the alert area, and so forth, conform to various requirements. The broadcast server 194 may provide the WEA message to eNodeB 111, eNodeB 112, and/or other eNodeBs or similar access network components to be broadcast to mobile devices that are being serviced by the cells of the alert area (and/or the broadcast area, which may include the alert area). In one example, a WEA message may be included in a system information block (SIB) that is broadcast by a cellular network radio unit (e.g., eNodeB 111 and/or eNodeB 112).

In accordance with the present disclosure, UEs 116 and 117 may be further configured for and capable of non-cellular wireless communications, such as in accordance with Institute of Electrical and Electronics Engineers (IEEE) 802.11 (Wi-Fi), IEEE 802.15 based communications (e.g., “Bluetooth,” “ZigBee,” etc.), and so forth, and/or wired network connectivity (e.g., Ethernet, or the like). In addition, UEs 116 and 117 may each comprise a computing system, such as computing system 300 depicted in FIG. 3, and may be configured to provide one or more functions in connection with examples of the present disclosure for configuring at least a first network element associated with a first cell site to apply at least one of a first plurality of values for at least one of a plurality of configurable settings based on an output of a location-based services recommendation module. For example, UEs 116 and 117 may collect performance metrics associated with a wireless emergency alert message or other location-based services and may transmit the performance metrics to AS 190, a wireless emergency alert performance application server (e.g., WEA-PAS 182), and/or other network-based systems, in accordance with the present disclosure.

The WEA performance application server (WEA-PAS) 182 may be in communication with alert originator devices 185 and/or IPAWS-OPEN server 189, one or more cellular networks (such as CMSP network 101), and various cellular endpoint devices (such as UEs 116 and 117). In one example, WEA-PAS 182 may comprise a computing device or processing system, such as computing system 300 depicted in FIG. 3, and may be configured to gather, aggregate, and/or compute performance metrics, e.g., relating to WEA message broadcasts, and for performing various other operations in accordance with the present disclosure.

In accordance with the present disclosure, either or both of the UEs 116 and 117 may receive a broadcast WEA message (e.g., from one of the eNodeBs 111 or 112). In addition, either or both of the UEs 116 and 117 may collect performance metrics associated with the WEA message, e.g., pertaining to reliability, latency, and/or accuracy, and may transmit the collected performance metrics to a WEA performance application server (WEA-PAS) 182 (and/or to AS 190). In accordance with the present disclosure, endpoint devices (e.g., including UEs 116 and 117) may be configured to alternatively or additionally transmit/upload WEA performance metrics via non-cellular access network modalities, such as via wireless local area network (WLAN) (e.g., a Wi-Fi network), a wired local area network (LAN) (e.g., an Ethernet network, etc.), and so forth. For instance, as illustrated in FIG. 1, network(s) 113 may represent various types of non-cellular access networks and/or the Internet in general. Accordingly, UEs 116 and 117 may upload WEA performance metrics to WEA-PAS 182 when non-cellular network connectivity via network(s) 113 is available.

In any case, WEA-PAS 182 may collect and store WEA performance metrics from various endpoint devices, e.g., including at least UEs 116 and 117. In various examples, WEA-PAS 182 may aggregate WEA performance metrics, e.g., organized by each WEA message, by alert area, by cell site, over a defined number of WEA messages and/or over a defined period of time, and so forth. In one example, WEA-PAS 182 may generate one or more aggregate metrics derived from performance data sets from a plurality of endpoint devices associated with one or more WEA message broadcasts. For instance, the one or more aggregate metrics may include one or more reliability measures, one or more latency measures, and/or one or more accuracy measures. WEA-PAS 182 may generate and/or transmit one or more reports relating to WEA message broadcasts. For instance, the report may include one or more aggregate metrics (e.g., latency, reliability, and/or accuracy), e.g., to AS 190. Alternatively, or in addition, the one or more reports may be generated and/or transmitted upon request.

In accordance with the present disclosure, performance data collection and reporting by WEA-capable endpoint devices may be enabled via an application programming interface (API) and corresponding application software (app) to allow for appropriate data capture and sharing, consistent with user preferences, cellular mobile service provider (CMSP), endpoint device and/or operating system (OS) vendor privacy policies, federal, state, and local laws and/or regulatory requirements, and so forth. In this regard, it should be noted that users may be requested, but not necessarily required to opt-in their endpoint devices for WEA performance data collection and reporting. In other words, the users will provide their affirmative consent before such data capture will be implemented.

Reliability of a WEA message may be defined as the total number of WEA capable endpoint devices in the alert area that received the alert divided by the total number of WEA capable devices in the alert area. Latency of a WEA message may be defined as end-to-end timing (from AO issuance of the WEA message until presentation on a WEA-capable endpoint device). Accuracy of a WEA message may be defined as the location of an endpoint device as compared to the alert area when the WEA message is presented. For all of the foregoing, the total number of endpoint devices in a broadcast area and/or an alert area that are capable of receiving broadcast WEA messages may be determined in a number of ways. For instance, a cellular network operator may track the number of endpoint devices/UEs that are attached/registered to each cell site, or that have been attached to each cell site in a recent time period. However, in one example, it is not possible to count a number of endpoint devices that are turned off or that are in airplane mode within an area based solely upon network-side records. In one example, endpoint devices that are within the broadcast area or within a certain defined range/distance nearby (e.g., within a designated time period before or after the broadcasting of a WEA message) may be requested to report estimated location information, such as may be obtained via Wi-Fi connection information, GPS location information, etc. Accordingly, the cellular network operator may further estimate the number of “off network” endpoint devices in the broadcast/notification area and/or the alert area.

In accordance with the present disclosure, BMC 194 may include a plurality of configurable settings relating to determining how far within a coverage area it can broadcast a WEA message, selecting which cell sites to use to broadcast, a retransmission rate, a retransmission duration, and so forth. In addition, the access network 103 and/or eNodeBs 111 and 112 may have a plurality of configurable settings relating to the broadcast of WEA messages, such as parameters relating to a system information block (SIB) (e.g., SIB 13, or the like), such as the length of the system information (SI)-window, the retransmission period for WEA messages (e.g., SIB 13), beam sweeping of a physical downlink shared channel (PDSCH) for one or more SIBs, and so forth. In one example, AS 190 may select values for one or more of the plurality of configurable settings in accordance with the example method 300 of FIG. 3 and/or as describe elsewhere herein. In addition, AS 190 may transmit these settings to BMC 194 or other network elements in accordance therewith.

In the example of FIG. 1, gateway mobile location center (GMLC) 199 may be configured to gather, store, and/or calculate location information of endpoint devices associated with CMSP network 101. For instance, location information may be obtained from the endpoint devices themselves (e.g., UEs 116 and 117) and/or from one or more network elements, such, as eNodeBs 111 and 112. For instance, UEs 116 and 117 may include Global Positioning System (GPS) units or other global navigation satellite system (GNSS) units, which may determine endpoint device locations. Alternatively, or in addition, UEs 116 and 117 may derive locations using other location estimation methods, such as cell identifier (cell ID) based methods, observed time difference of arrival (OTDA) techniques, or barycentric triangulation. In one example, UEs 116 and 117 may also determine respective altitudes and/or elevations. For instance, UEs 116 and 117 may each be equipped with a gyroscope, a compass, an atmospheric pressure sensor (e.g., an altimeter), and so forth. Alternatively, or in addition, eNodeBs 111 and 112, MME 107, and/or GMLC 199 may determine endpoint device locations via one or more methodologies, such as observed time difference of arrival (OTDA) techniques, or barycentric triangulation, uplink time difference of arrival (UL-TDOA), positioning methods based on power measurements, round trip time (RTT) and angle-based positioning, and so forth. In various examples, location determination/calculation may be based upon reference signals, such as the positioning reference signal (PRS) in the downlink and the sounding reference signal (SRS) in the uplink.

In accordance with the present disclosure, LTE network 102 may include a plurality of configurable settings relating to endpoint device location determination. For instance, the configurable settings may be related to eNodeBs 111 and 112, MME 107, GMLC 199, and/or endpoint devices 116 and 117. In one example, AS 190 may select values for one or more of the plurality of configurable settings in accordance with the example method 200 of FIG. 2 and/or as described elsewhere herein. In addition, AS 190 may transmit these settings to eNodeBs 111 and 112, or other network elements in accordance therewith. To further illustrate, the positioning reference signal (PRS) may have a configurable delay spread range, comb size, and other factors. In one example, the PRS may also have a selectable beam sweep pattern, a beamwidth, a transmit power, and so forth. One or both of the SRS and the PRS may have configurable settings, or parameters, for a repeatability, repetition rate, repetition pattern, or the like. Similarly, one or both of the SRS and PRS may have a configurable setting comprising a waveform selected from among a plurality of available waveform types.

Notably, endpoint device GPS location information may not be the most accurate or reliable in various situations. For instance, uplink and/or downlink triangulation measures may be more accurate that GPS for indoor locations, particularly in dense urban environments. In one example, indoor positioning systems may be available to supplement or supersede other measures. In one example, still other configurable settings may include weightings/ratios for identifying endpoint device locations comprising a combination of measurements from GPS and other techniques. Thus, for instance, in a dense urban environment, an endpoint device location determined by GMLC 199 may consider uplink SRS triangulation measures more heavily than GPS coordinates obtained directly from endpoint devices. However, in a rural area with large cells and long distances between cell sites/base stations, endpoint device GPS location information may be given a more substantial weighting.

In this regard, it should be noted that GMLC 199 may accumulate and store location information from a variety of sources and may aggregate the location information for various endpoint devices attached to or otherwise tracked by LTE network 102. GMLC 199 may store the location information as the measures are received from other entities and/or may store averages or composite location information calculated from location information from multiple sources, may calculate and store averages from the same source (e.g., 1 minute moving averages, 5 minute averages of location information, etc.), pseudo-anonymized location information (e.g., locations that are randomized within a geofence or other reference zones around an actual location), and so forth. In one example, GMLC 199 may make available endpoint device location information to other authorized entities providing location-based services, e.g., as a data feed and/or in response to queries from such entities, e.g., emergency calling services, emergency messaging services, emergency alert broadcast services, mapping and visualization services for first responder personnel and equipment tracking, navigation services, video streaming services, and so forth. For instance, entities in FIG. 1 providing location-based services may include server(s) 175, alert originator device(s) 185, PSAP(s) 160 or elements of service network 140 (e.g., an ESInet) and so forth.

To further illustrate, in an example in which UE 116 place a call or text to 9-1-1. EPC network 105 may identify the call as an emergency call (E911) (or emergency message (e.g., text-2-911)) and may route the call/message to an appropriate PSAP (e.g., one of PSAPs 160), based on the location of UE 116. For instance, this may be based upon location information from GMLC 199 and/or from the most recent location information held by MME 107. In one example, the location of UE 116 may be provided to the selected one of PSAPs 160 in conjunction with the forwarding of the call or message. As such, this may permit the selected one of PSAPs 160 to dispatch emergency personnel to the location of UE 116 with improved accuracy. For instance, in one example, GMLC 199 may provide coordinates, a likely street address, a likely floor of a building, etc. with an accuracy metric (e.g., within 100 meters, within 10 meters, etc.). In one example, elements of service network 140 and/or PASPs 160 may request location information of first responder endpoint devices and/or network-connected equipment (e.g., ambulances, fire trucks/engines, etc.) from GMLC 199, which may be similarly collected and stored. As such, service network 140 and/or PSAPs 160 may track estimated times for personnel or equipment to reach an emergency services caller, may provide visualizations on maps or the like to aid dispatchers in providing directions to personnel and/or the caller, and so forth. Service network 140 may similarly provide or enable improved location-based services in situations that do not necessarily involve an E911 caller or the like. For instance, there may be a widespread incident where search and rescue personnel may be performing dwelling to dwelling checks, without specific calls from such dwellings. However, it may still be beneficial to track and provide accurate locations for the search and rescue personnel and/or equipment, e.g., as can be tracked by EPC network 105 from their network-connected endpoint devices. Likewise, a video streaming service (e.g., represented by server(s) 175) may obtain location information of UE 117 from GMLC 199, and may direct UE 117 to obtain video content from a closest server, a server with the least latency, etc. (e.g., a content distribution network (CDN) edge server, or the like) based upon the location information of UE 117. Thus, these and other examples are all contemplated within the scope of the present disclosure.

To further illustrate, AS 190 may select values for one or more configurable settings of one or more network elements, e.g., configurable settings that may be associated with location-based services. In one example, AS 190 may implement a location-based services prediction model. For instance, the location-based services prediction model may be configured to output values for one or more configurable settings based upon an input vector comprising characteristics associated with a cell site of CMSP network 101. For instance, AS 190 may train a location-based service prediction model with a training data set comprising a plurality of training samples, e.g., where each training sample comprises a set of predictor values and a set of labels. For example, predictor values may comprise characteristics associated with a respective cell site, and labels (or sets of labels) may comprise respective set of values for a plurality of configurable settings that are implemented via one or more network elements associated with the respective cell site. For instance, the characteristics may include: characteristics of one or more network elements associated with the cell site, geographic information of the cell site, demographic information of the cell site, and so forth.

In one example, the location-based services prediction model may comprise one or more machine learning models that is/are trained to output/select one or more configuration setting values further based upon one or more performance indicators. For example, the at least one performance indicator may comprise one or more of: a call success rate associated with emergency services calls, a location accuracy associated with an emergency services call, a call location-based route success rate, a text-to-911 service message success rate, and so forth. Similarly, for a machine learning model associated with WEA messages, the at least one performance indicator may comprise one or more reliability, latency, and/or accuracy measures. In one example, the location-based services prediction model may balance the performance of different location-based services. For instance, the location-based services prediction model may comprise an ensemble where recommended values for configurable settings from a first MLM trained for optimized performance for WEA messages may be balanced with recommended values for the configurable settings from a second MLM that is trained for optimized performance for E911 call processing. In one example, the location-based services recommendation module may comprise an aggregation layer to combine respective outputs of the plurality of location-based service prediction models to generate the output of the location-based services recommendation module. In one example, the aggregation layer may itself comprise a machine learning model that is trained to combine the respective outputs of the plurality of location-based service prediction models, e.g., according to a loss function, chi-square/goodness of fit test, etc.

It should be noted that as referred to herein, a machine learning model (MLM) (or machine learning-based model), may comprise a machine learning algorithm (MLA) that has been “trained” or configured in accordance with input data (e.g., training data) to perform a particular service, e.g., to select values for one or more configurable settings for one or more network elements associated with one or more location-based services, or the like. Examples of the present disclosure may incorporate various types of MLAs/models that utilize training data, such as support vector machines (SVMs), e.g., linear or non-linear binary classifiers, multi-class classifiers, deep learning algorithms/models, such as deep learning neural networks or deep neural networks (DNNs), graph neural networks (GNNs), generative adversarial networks (GANs), decision tree algorithms/models, k-nearest neighbor (KNN) clustering algorithms/models, a random forest model, a convolutional neural network (CNN), such as an AlexNet model, a WaveNet model, or the like, a recurrent neural network (RNN), a long short-term memory (LSTM) model, and so forth. In one example, an MLA may incorporate an exponential smoothing algorithm, reinforcement learning (e.g., using positive and negative examples after deployment as a MLM), and so forth. In one example, an MLM of the present disclosure may be in accordance with a MLA/MLM template from an open source library, such as OpenCV, which may be further enhanced with domain specific training data.

In one example, the MLA/MLMs of the present disclosure may continue to be trained/retrained and/or updated as new training data is obtained and/or as performance data is collected. For instance, the MLA/MLMs of the present disclosure may be trained and updated on an ongoing basis via reinforcement learning (RL). For example, as configurable settings are adjusted, AS 190 may observe corresponding performance indicators to determine if setting changes result in positive improvements or negative degradations in performance. Similarly, network personnel may provide indications of “correct” configuration settings and/or “incorrect” configuration settings, e.g., through manual adjustment of one or more configurable setting values after an automatic selection by AS 190, and so forth. This feedback may be used to provide new labeled examples for additional model training or correction. These and other aspects of the present disclosure are described in greater detail below in connection with the example of FIG. 2.

It should be noted that the foregoing description of the system 100 is provided as an illustrative example only. In other words, the example of system 100 is merely illustrative of one network configuration that is suitable for implementing embodiments of the present disclosure. For example, AS 190, BMC 194, GMLC 199, PASP(s) 160, WEA-PAS 182, and/or other network components may be deployed in other portions of system 100 that are not shown, while providing essentially the same functionality. In still another example, system 100 may be configured such that communications between IPAWS-OPEN server 189 and/or alert originator devices 185 and AS 190 may bypass PDN gateway(s) 110, and other components. For instance, dedicated gateways and network connections that are not shared with other external entities may be provided for guaranteeing access by IPAWS-OPEN server 189 and/or alert originators device 185 to AS 190. For example, a WEA gateway 192 may be included as a point of ingress to and egress from EPC network 105 for communications between IPAWS-OPEN server 189 and/or alert originator devices 185 in alert originating network(s) 180 and AS 190 in EPC network 105. Such a WEA gateway 192 may alternatively be referred to as a commercial mobile service provider (CMSP) gateway or a commercial mobile alert system (CMAS) gateway. Similarly, in one example, WEA-PAS 180 may be deployed CMSP network 101. In one example, an ESInet may be external to CMSP network 101. In addition, various elements of access network 103 and EPC network 105 are omitted for clarity, including gateways or border elements providing connectivity between such networks.

Furthermore, although aspects of the present disclosure have been discussed above in the context of a long term evolution (LTE)-based wireless network, examples of the present disclosure are not so limited. Thus, the teachings of the present disclosure can be applied to other types of wireless networks (e.g., 2G network, 3G network, 5G network, a future 6G network, and the like). Thus, these and other modifications are all contemplated within the scope of the present disclosure.

FIG. 2 illustrates a flowchart of an example method 200 for configuring at least a first network element associated with a first cell site to apply at least one of a first plurality of values for at least one of a plurality of configurable settings based on an output of a location-based services recommendation module. In one example, the steps, operations or functions of the method 200 may be performed by any one or more of the components of the system 100 depicted in FIG. 1. For example, in one embodiment, the method 200 is performed by application server 190, or by AS 190 in coordination with other components of the system 100, such as eNodeBs 111 and 112, GMLC 199, BMC 194, WEA-PAS 182, and so forth. Alternatively, or in addition, the steps, functions and/or operations of the method 200 may be performed by a processing system collectively comprising a plurality of devices as illustrated in FIG. 1 such as one or more of AS 190, eNodeBs 111 and 112, BMC 194, GMLC 199, and so forth. In one example, the steps, functions, or operations of method 200 may be performed by a computing device or processing system, such as computing system 300 and/or a hardware processor element 302 as described in connection with FIG. 3 below. For instance, the computing system 300 may represent at least a portion of a platform, a server, a system, and so forth, in accordance with the present disclosure. In one example, the steps, functions, or operations of method 200 may be performed by a processing system comprising a plurality of such computing devices as represented by the computing system 300. For illustrative purposes, the method 200 is described in greater detail below in connection with an example performed by a processing system.

The method 200 begins in step 205 and may proceed to optional step 210 or to step 220.

At optional step 210, the processing system may train at least one location-based service prediction model with a training data set comprising a plurality of training samples. For instance, each training sample may comprise a set of predictor values and a set of labels. In one example, each set of predictor values may comprise characteristics associated with a respective cell site. The characteristics may include characteristics of the one or more network elements, geographic information of the respective cell site, and/or demographic information of the respective cell site, or the like. For instance, the characteristics of the network element(s) may include: a type of network element, a network element manufacturer, a network element model type, a number of sectors, an antenna azimuth, an antenna elevation, an antenna tilt, an antenna beamwidth, an antenna coverage angle, an antenna count/number of antennas, or one or more antenna operational bands, an operating system type, an operating system vendor, and so forth. In addition, the geographic information may comprise: a cell site location, a cell site elevation, a cell site terrain description, a tracking area code, and so forth. In one example, the demographic information may comprise a population density metric, a building density metric, etc. The characteristics may be obtained from one or more sources, such as a network inventory database, a network topology database (e.g., a graph database), an operation support system (OSS) database, or the network elements directly.

In addition, each set of labels may comprise a respective set of values for a plurality of configurable settings that are implemented via one or more network elements associated with the respective cell site. For instance, the plurality of configurable settings may include: a bandwidth allocated to a positioning reference signal (PRS), a number of symbols aggregated for the PRS, a comb size of the PRS, at least one beamforming setting for a sounding reference signal (SRS), at least one beamforming setting for a WEA broadcast, at least one system information block (SIB) setting for the WEA broadcast, a repetition rate for the WEA broadcast, a repetition duration for the WEA broadcast, and so forth. In one example, at least one of the plurality of configurable settings may be associated with a dedicated slice of the communication network that is reserved for first responder use and/or governmental use. In one example, the plurality of configurable settings may include at least one configurable setting of a gateway mobile location center (GMLC) or at least one configurable setting of a broadcast message center (BMC), such as described above. It should be noted that in various examples, some of the above may be “characteristics” (e.g., fixed and/or non-configurable by the processing system), while in other examples, some may be configurable settings (such as tilt, gain, beamwidth, or the like). In other words, in some examples, one or more of the above “characteristics” could instead comprise a configurable setting (and may thus be associated with corresponding label values in respective training samples).

In one example, the training samples may comprise “positive” samples, e.g., sets of values for the plurality of configurable settings that indicate positive performance associated with at least one location-based service. In one example, the training samples may further include “negative” samples, e.g., sets of values for the plurality of configurable settings that indicate negative or reduced performance associated with the at least one location-based service. Alternatively, or in addition, in one example, each set of labels may also include one or more performance labels, e.g., one or more values for one or more performance metrics. For instance, as described above, the one or more performance metrics may include a call success rate associated with emergency services calls, a location accuracy associated with an emergency services call, a call location-based route success rate, a text-to-911 service message success rate, and so forth, WEA reliability, latency, and/or accuracy measures, etc. For example, for E 9-1-1 caller location accuracy, feedback may be obtained from first responders or the like. For the call location-based route success rate, feedback may be obtained from PASP systems and/or personnel, and similarly for other performance indicators. In one example, the at least one performance indicator may include a call defect rate (e.g., overall and/or by call technology (e.g., voice over LTE (VOLTE), voice over Wi-Fi (VoWiFi), etc.), such as call defects per million (DPM) or the like.

In one example, the at least one location-based service prediction model may be trained in accordance with a loss function, chi-square/goodness of fit test, etc. It should be noted that the at least one location-based service prediction model may be trained for a defined objective. For instance, accurate location may be a universal goal for all location-based services. However, for first responder services, 911 emergency services, or other location-based services, the objectives may sometimes allow that the fastest experience and/or the most accurate location may be sacrificed to help ensure that communications go through (e.g., as defined by one or more reliability metrics). For instance, it may be desirable to have precise location on all first responders addressing an incident, but some location accuracy may be sacrificed to further ensure that the reliability of two-way communications is as high as possible (e.g., for firemen fighting a fire event), exceeds a threshold reliability measure, or the like.

In one example, the at least one location-based service prediction model may comprise at least one machine learning model (MLM). For instance, the at least one MLM may comprise a deep neural network (DNN), a convolutional neural network (CNN), a long short-term memory (LSTM) model, an autoencoder neural network, or the like. In one example, the at least one MLM may comprise a multivariate MLM, e.g., where the output may comprise a plurality of values for a plurality of configurable settings. In one example, the at least one location-based service prediction model may comprise a plurality of location-based service prediction models, where each is associated with a different one of a plurality of location-based services. For instance, the plurality of location-based services may include a WEA service, an enhanced 9-1-1 service, a text-2-911 messaging service, a first responder location tracking service, or the like. Alternatively, or in addition, the plurality of location-based services may include a video streaming service, a navigation service, etc.

In one example, the at least one location-based service prediction model may be part of a location-based services recommendation module. For instance, the location-based services recommendation module may comprise the at least one location-based service prediction model. Accordingly, in one example, step 210 may comprise training the location-based services recommendation module (e.g., training the one or more component MLMs). In one example, the location-based services recommendation module may also comprise an aggregation layer to combine respective outputs of a plurality of component location-based service prediction models to generate the output of the location-based services recommendation module. For instance, the location-based services recommendation module may comprise an ensemble MLM. In one example, the aggregation layer may also comprise a machine learning model. For instance, the aggregation layer may be trained to combine the respective outputs of the plurality of location-based service prediction models, e.g., according to a loss function, chi-square/goodness of fit test, etc. that may be based upon one or more performance metrics such as described above.

At step 220, the processing system applies an input vector to the location-based services recommendation module comprising the at least one location-based service prediction model. For instance, the input vector may comprise first characteristics associated with a first cell site of a cellular network. The first characteristics may be of the same types as described above, e.g., characteristics of one or more network elements of the first cell site, geographic information of the first cell site, and/or demographic information of the first cell site, or the like.

At step 230, the processing system obtains an output of the location-based services recommendation module in response to the applying of the input vector. It should be noted that the location-based services recommendation module is implemented by the processing system, e.g., in operating thereon in accordance with instructions loaded into memory and executed by the at least one processor. Thus, step 230 may include the processing system generating the output via computations and algorithmic execution of code in accordance with the trained location-based services recommendation module. As described above, the output may comprise a first plurality of values for a plurality of configurable settings of at least a first network element associated with the first cell site. For instance, the plurality of configurable settings may include: a bandwidth allocated to a PRS, a number of symbols aggregated for the PRS, a comb size of the PRS, at least one beamforming setting for a SRS, at least one beamforming setting for a WEA broadcast, at least one SIB setting for the WEA broadcast, a repetition rate for the WEA broadcast, a repetition duration for the WEA broadcast, and so forth.

In one example, the plurality of configurable settings may include at least one configurable setting of a GMLC or at least one configurable setting of a BMC, such as described above. For example, a GMLC may be configured to subscribe to location information that is updated every 0.5 seconds for all UEs. However, this may generate congestion such that two-way communications for first responders may degrade. Thus, in accordance with the output of the location-based services recommendation module (and based upon training/learning from the training data set) the GMLC may instead be assigned to subscribe to location information with two-second accuracy, e.g., on a two-second update basis. Likewise, a BMC may be assigned and/or may select a retransmission rate that is dependent upon characteristics of the cell site in consideration of experience at similar cell sites in the past based upon the machine learning.

At step 240, the processing system configures the at least the first network element associated with the at least the first cell site to apply at least one of the first plurality of values for at least one of the plurality of configurable settings. For instance, step 240 may include transmitting one or more instructions to the at least the first network element to apply the value(s) to the configuration setting(s). In one example, step 240 may include configuring the at least the first network element to apply all or a portion of first plurality of values for respective configurable settings. In other words, in one example, one or more configurable settings may have recommended values in the output of step 230 that is/are not implemented in accordance with step 240. For instance, some configurable settings may be designated as not automatically adjustable. In one example, values for such configurable setting(s) may be recommended for implementation and/or change, where network personnel (or other automated network-based system) may authorize or reject these recommended values. In one example, the processing system may be permitted to adjust values for configurable settings within a range (or to designated values within a set of available setting values) automatically, while values outside of such range(s) or sets may call for recommendation and approval/disapproval. For instance, the positioning reference signal may be assigned a bandwidth within a range of bandwidth values, but may not be reduced below a threshold bandwidth or increased above a threshold bandwidth without approval. In one example, the first cell may have existing/baseline configurations based on predefined rules, where the processing system may later make changes. For instance, as long as minimum performance thresholds are maintained, the processing system may be allowed to make changes for LBS optimization. The “performance thresholds” may relate to the same or different performance indicators such as used for LBS optimization. In one example, some configuration settings may be general and broadly applicable to various network operations, while others may be more specific to LBS, such as the PRS, SRS, SIB, etc., retransmission rate. In one example, the LBS specific configuration settings may be permitted to be automatically adjusted by the processing system, while other more general configuration settings may be protected (e.g., these may be changed by approval after recommendation by the processing system). In addition, in one example, network personnel may add (or remove) configuration settings that are to be considered off-limits for automatic adjustment, or for which change recommendations may be made by the processing system, but which require user approval to actually implement.

At optional step 250, the processing system may detect an adjustment to the at least one of the first plurality of values for the at least one of the plurality of configurable settings. Alternatively, or in addition, optional step 250 may include obtaining a feedback label for the first plurality of values for the at least one of the plurality of configurable settings. For instance, as noted above, network personnel may manually adjust a configurable setting to a different value than that which is selected by the processing system. In one example, the network personnel may provide a specific indication that the adjustment is intended to override the prior selection of the processing system (e.g., in another example, the network personnel may make the adjustment without regard to how it may affect location-based services, and may thus be treated differently with respect to how the adjustment may affect retraining/updating of the at least one location-based service prediction model).

At optional step 260, the processing system may obtain at least one performance indicator associated with the first cell site and associated with the at least one location-based service, e.g., where the at least one location-based service prediction model is associated with at least one location-based service as described above. For instance, the at least one performance indicator may comprise a call success rate associated with emergency services calls, a location accuracy associated with emergency services calls, a call location-based route success rate, a text-to-911 service message success rate, and so forth, e.g., over a designated period of time, number of calls, number of messages, or the like. The at least one performance indicator may alternatively or additionally comprise a WEA reliability, latency, and/or accuracy measures, etc., e.g., for a particular WEA message broadcast, over a designated period of time, over a defined number of WEA message broadcasts, and so forth.

At optional step 270, the processing system may update the at least one location-based service prediction model in accordance with the adjustment to the at least one of the first plurality of values for the at least one of the plurality of configurable settings (e.g., which may be detected in optional step 250) and/or in accordance with the at least one performance indicator (e.g., which may be obtained in optional step 260). For instance, in one example, optional step 270 may include retraining the at least one location-based service prediction model with an additional training sample comprising the first characteristics associated with the first cell site and a set of values for the plurality of configurable settings that are implemented at the first cell site, e.g., where the set of values includes at least one adjusted value in accordance with the adjustment to the at least one of the first plurality of values for the at least one of the plurality of configurable settings that may be detected at optional step 250. For instance, the set of values may comprise a label (or labels) for the training sample. Alternatively, or in addition, optional step 270 may include retraining the at least one location-based service prediction model with an additional training sample comprising the first characteristics associated with the first cell site, a set of values for the plurality of configurable settings that are implemented at the first cell site (e.g., “labels”), and the at least one performance indicator or a value associated with the at least one performance indicator (e.g., one or more additional labels of a set of labels for the additional training sample).

Following step 240 or optional step 270, the method 200 proceeds to step 295 where the method 200 ends.

It should be noted that the method 200 may be expanded to include additional steps or may be modified to include additional operations or omit operations with respect to the steps outlined above. For example, the method 200 may be repeated through various cycles of steps 220-240 or steps 220-270 for the first cell site at successive times and/or for different cell sites. In one example, the location-based services recommendation module may include a ticket monitoring module. For instance, in one example, the ticket monitoring module may comprise a k-means clustering model and the method 200 may include updating the ticket monitoring module based upon each ticket that is received relating to a particular location-based service and/or a performance indicator associated with such location-based service (e.g., a ticket relating to poor call quality of an E 9-1-1 service call, a ticket relating to alleged location-tracking mistakes of a navigation service, and so forth). In one example, there may be “soft alarms” involving more ticketing or degradation of one or more performance indicators (e.g., based on cluster size or the like), where network personnel may be warned that there is a possible problem/misconfiguration, and more urgent warnings where intervention can be made before issues reach UEs (e.g., where more active monitoring can take place by network personnel and/or where changes can be made automatically by the processing system in real time or close to real time). In one example, the location-based services recommendation module and the at least one location-based service prediction model thereof may relate to a plurality of cells in a “configuration group.” For instance, the method 200 may further include jointly optimizing a plurality of cells as a group, where the training data may similarly be by configuration group. In one example, the method 200 may be expanded or modified to include steps, functions, and/or operations, or other features described in connection with the example(s) of FIG. 1, or as described elsewhere herein. Thus, these and other modifications are all contemplated within the scope of the present disclosure.

In addition, although not specifically specified, one or more steps, functions or operations of the method 200 may include a storing, displaying and/or outputting step as required for a particular application. In other words, any data, records, fields, and/or intermediate results discussed in the method 200 can be stored, displayed, and/or outputted either on the device executing the respective method or to another device, as required for a particular application. Furthermore, steps, blocks, functions, or operations in FIG. 2 that recite a determining operation or involve a decision do not necessarily require that both branches of the determining operation be practiced. In other words, one of the branches of the determining operation can be deemed as an optional step. Moreover, steps, blocks, functions, or operations of the above described method 200 can be combined, separated, omitted, and/or performed in a different order from that described above, without departing from the examples of the present disclosure.

FIG. 3 depicts a high-level block diagram of a computing system 300 (e.g., a computing device, or processing system) specifically programmed to perform the functions described herein. For example, any one or more components or devices illustrated in FIG. 1, or described in connection with the method 200 of FIG. 2 may be implemented as the computing system 300. As depicted in FIG. 3, the computing system 300 comprises a hardware processor element 302 (e.g., comprising one or more hardware processors, which may include one or more microprocessor(s), one or more central processing units (CPUs), and/or the like, where hardware processor element may also represent one example of a “processing system” as referred to herein), a memory 304, (e.g., random access memory (RAM), read only memory (ROM), a disk drive, an optical drive, a magnetic drive, and/or a Universal Serial Bus (USB) drive), a module 305 for configuring at least a first network element associated with a first cell site to apply at least one of a first plurality of values for at least one of a plurality of configurable settings based on an output of a location-based services recommendation module, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 302 is shown, it should be noted that the computing device may employ a plurality of hardware processor elements. Furthermore, although only one computing device is shown in FIG. 3, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 3 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor element 302 can also be configured or programmed to cause other devices to perform one or more operations as discussed above. In other words, the hardware processor element 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for configuring at least a first network element associated with a first cell site to apply at least one of a first plurality of values for at least one of a plurality of configurable settings based on an output of a location-based services recommendation module (e.g., a software program comprising computer-executable instructions) can be loaded into memory 304 and executed by hardware processor element 302 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for configuring at least a first network element associated with a first cell site to apply at least one of a first plurality of values for at least one of a plurality of configurable settings based on an output of a location-based services recommendation module (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
applying, by a processing system including at least one processor, an input vector to a location-based services recommendation module comprising at least one location-based service prediction model, the input vector comprising first characteristics associated with a first cell site of a cellular network;
obtaining, by the processing system, an output of the location-based services recommendation module in response to the applying of the input vector, wherein the location-based services recommendation module is implemented by the processing system, and wherein the output comprises a first plurality of values for a plurality of configurable settings of at least a first network element associated with the first cell site; and
configuring, by the processing system, the at least the first network element associated with the first cell site to apply at least one of the first plurality of values for at least one of the plurality of configurable settings.

2. The method of claim 1, wherein the at least one location-based service prediction model comprises a plurality of location-based service prediction models, wherein each of the plurality of location-based service prediction models is associated with a different one of a plurality of location-based services.

3. The method of claim 2, wherein the plurality of location-based services comprises at least one of:
a wireless emergency alert service;
an enhanced 9-1-1 service;
a text-2-911 messaging service; or
a first responder location tracking service.

4. The method of claim 2, wherein the plurality of location-based services comprises at least one of:
a video streaming service; or
a navigation service.

5. The method of claim 1, wherein the first characteristics associated with the first cell site comprise at least one of:
characteristics of the at least the first network element associated with the first cell site of the cellular network;
geographic information of the first cell site; or
demographic information of the first cell site.

6. The method of claim 1, further comprising:
training the at least one location-based service prediction model with a training data set, wherein the training data set comprises a plurality of training samples, wherein each training sample comprises: a set of predictor values and a set of labels.

7. The method of claim 6, wherein each set of predictor values comprises characteristics associated with a respective cell site, and wherein each set of labels comprises a respective set of values for the plurality of configurable settings that are implemented via one or more network elements associated with the respective cell site.

8. The method of claim 6, further comprising:
detecting an adjustment to the at least one of the first plurality of values for the at least one of the plurality of configurable settings.

9. The method of claim 8, further comprising:
updating the at least one location-based service prediction model in accordance with the adjustment to the at least one of the first plurality of values for the at least one of the plurality of configurable settings.

10. The method of claim 9, wherein the updating comprises retraining the at least one location-based service prediction model with an additional training sample comprising the first characteristics associated with the first cell site and a set of values for the plurality of configurable settings that are implemented at the first cell site, the set of values including at least one adjusted value in accordance with the adjustment to the at least one of the first plurality of values for the at least one of the plurality of configurable settings.

11. The method of claim 6, wherein the at least one location-based service prediction model is associated with at least one location-based service.

12. The method of claim 11, further comprising:
obtaining at least one performance indicator associated with the first cell site and associated with the at least one location-based service.

13. The method of claim 12, further comprising:
updating the at least one location-based service prediction model in accordance with the at least one performance indicator.

14. The method of claim 12, wherein the at least one performance indicator comprises at least one of:
a wireless emergency alert accuracy;
a wireless emergency alert latency; or
a wireless emergency alert reliability.

15. The method of claim 12, wherein the at least one performance indicator comprises at least one of:
a call success rate associated with emergency services calls;
a location accuracy associated with an emergency services call;
a call location-based route success rate; or
a text-to-911 service message success rate.

16. The method of claim 12, wherein the at least one performance indicator comprises a call defect rate.

17. The method of claim 1, wherein the plurality of configurable settings comprises at least one of:
a bandwidth allocated to a positioning reference signal;
a number of symbols aggregated for the positioning reference signal;
a comb size of the positioning reference signal;
at least one beamforming setting for a sounding reference signal;
at least one beamforming setting for a wireless emergency alert broadcast;
at least one system information block setting for the wireless emergency alert broadcast;
a repetition rate for the wireless emergency alert broadcast; or
a repetition duration for the wireless emergency alert broadcast.

18. The method of claim 1, wherein the plurality of configurable settings comprises at least one of:
at least one configurable setting of a gateway mobile location center; or
at least one configurable setting of a broadcast message center.

19. A non-transitory computer-readable medium storing instructions which, when executed by a processing system including at least one processor, cause the processing system to perform operations, the operations comprising:
applying an input vector to a location-based services recommendation module comprising at least one location-based service prediction model, the input vector comprising first characteristics associated with a first cell site of a cellular network;
obtaining an output of the location-based services recommendation module in response to the applying of the input vector, wherein the location-based services recommendation module is implemented by the processing system, and wherein the output comprises a first plurality of values for a plurality of configurable settings of at least a first network element associated with the first cell site; and
configuring the at least the first network element associated with the first cell site to apply at least one of the first plurality of values for at least one of the plurality of configurable settings.

20. An apparatus comprising:
a processing system including at least one processor; and
a non-transitory computer-readable medium storing instructions which, when executed by the processing system, cause the processing system to perform operations, the operations comprising:
applying an input vector to a location-based services recommendation module comprising at least one location-based service prediction model, the input vector comprising first characteristics associated with a first cell site of a cellular network;
obtaining an output of the location-based services recommendation module in response to the applying of the input vector, wherein the location-based services recommendation module is implemented by the processing system, and wherein the output comprises a first plurality of values for a plurality of configurable settings of at least a first network element associated with the first cell site; and
configuring the at least the first network element associated with the first cell site to apply at least one of the first plurality of values for at least one of the plurality of configurable settings.
